(19) United States
(12) Patent Application Publication
(10) Pub. No.: US 2008/0170329 A1
(43) Pub. Date: Jul. 17, 2008

(54) Granular perpendicular magnetic recording media with improved corrosion resistance by SUL post-deposition heating

(75) Inventors: Raj Thangaraj, Fremont, CA (US); Huan Tang, Los Altos, CA (US); Jing Gui, Fremont, CA (US); John Wang, Fremont, CA (US); Tommy T. Cheung, Alameda, CA (US)

Correspondence Address: SEAGATE TECHNOLOGY LLC;c/o MCDERMOTT WILL & EMERY LLP, 600 13TH STREET, NW, WASHINGTON, DC, 20005-3096, US

(73) Assignee: SEAGATE TECHNOLOGY LLC

(21) Appl. No.: 11/651,964

(22) Filed: Jan. 11, 2007

(51) Int. Cl. G11B 5/74

(52) U.S. Cl. 360/131

(57) ABSTRACT

A method of manufacturing a granular perpendicular magnetic recording medium with improved corrosion resistance comprises sequential steps of providing a non-magnetic substrate including a surface; forming a soft magnetic underlayer (SUL) over the surface; post-deposition heating the SUL; forming an intermediate layer stack over the heated SUL; and forming at least one granular, magnetically hard perpendicular magnetic recording layer over the intermediate layer stack. Heating of the SUL prior to formation of the intermediate layer stack results in formation of an intermediate layer stack with a smoother surface and a granular perpendicular recording layer with increased corrosion resistance than when SUL post-deposition heating is not performed.

### FIELD OF THE INVENTION

The present invention relates to high recording performance magnetic recording media with improved corrosion resistance, comprising a granular perpendicular magnetic recording layer, and to methods of manufacturing same. The invention has particular utility in the manufacture and use of high areal recording density, corrosion-resistant magnetic media, e.g., hard disks, utilizing granular recording layers.

### BACKGROUND OF THE INVENTION

Magnetic media are widely used in various applications, particularly in the computer industry for data/information storage and retrieval applications, typically in disk form, and efforts are continually made with the aim of increasing the areal recording density, i.e., bit density of the magnetic media. Conventional thin film thin-film type magnetic media, wherein a fine-grained polycrystalline magnetic alloy layer serves as the active recording layer, are generally classified as “longitudinal” or “perpendicular”, depending upon the orientation of the magnetic domains of the grains of magnetic material.

Perpendicular recording media have been found to be superior to the more conventional longitudinal media in achieving very high bit densities. In perpendicular magnetic recording media, residual magnetization is formed in a direction (easy axis”) perpendicular to the surface of the magnetic medium, typically a layer of a magnetic material on a suitable substrate. Very high linear recording densities are obtainable by utilizing a “single-pole” magnetic transducer or “head” with such perpendicular magnetic media.

At present, efficient, high bit density recording utilizing a perpendicular magnetic medium requires interposition of a relatively thick (as compared with the magnetic recording layer), magnetically “soft” underlayer (“SUL”), i.e., a magnetic layer having a relatively low coercivity typically not greater than about 1 kOe, such as of a NiFe alloy (Permalloy), between a non-magnetic substrate, e.g., of glass, aluminum (Al) or an Al-based alloy, and a magnetically “hard” recording layer having relatively high coercivity, typically about 3-8 kOe, e.g., of a cobalt-based alloy (e.g., a Co—Cr alloy such as CoCrPtB) having perpendicular anisotropy. The magnetically soft underlayer serves to guide magnetic flux emanating from the head through the magnetically hard perpendicular recording layer.

More specifically, a major function of the SUL is to focus magnetic flux from a magnetic writing head into the magnetically hard recording layer, thereby enabling higher writing resolution than in media without the SUL. The SUL material therefore must be magnetically soft, with very low coercivity, e.g., not greater than about 1 kOe, as indicated above. The saturation magnetization Mₛ must be sufficiently large such that the flux saturation from the write head is completely absorbed therein without saturating the SUL.

A conventionally structured perpendicular recording system 10 with a perpendicularly oriented magnetic medium 1 and a magnetic transducer head 9 is schematically illustrated in cross-section in FIG. 1, wherein reference numeral 2 indicates a non-magnetic substrate, reference numeral 3 indicates an optional adhesion layer, reference numeral 4 indicates a relatively thick magnetically soft underlayer (SUL), reference numeral 5 indicates an intermediate layer stack comprising a seed layer 5_{B} adjacent SUL 4 and at least one overlying non-magnetic interlayer 5_{A} of an hcp material, and reference numeral 6 indicates at least one relatively thin magnetically hard perpendicular recording layer with its magnetic easy axis perpendicular to the film plane.

Still referring to FIG. 1, reference numerals 9_{M} and 9_{A}, respectively, indicate the main (writing) and auxiliary poles of the magnetic transducer head 9. The relatively thin intermediate layer stack 5 serves to (1) prevent magnetic interaction between the magnetically soft underlayer (SUL) 4 and the at least one magnetically hard recording layer 6; and (2) promote desired microstructural and magnetic properties of the at least one magnetically hard recording layer 6.

As shown by the arrows in the figure indicating the path of the magnetic flux φ, flux φ emanates from the main writing pole 9_{M} of magnetic transducer head 9, enters and passes through the at least one vertically oriented, magnetically hard recording layer 6 in the region below main pole 9_{M}, enters and travels within soft magnetic underlayer (SUL) 4 for a distance, and then exits therefrom and passes through the at least one perpendicular hard magnetic recording layer 6 in the region below auxiliary pole 9_{A} of transducer head 9. The relative direction of movement of perpendicular magnetic medium 21 past transducer head 9 is indicated in the figure by the arrow in the figure.

Completing the layer stack of medium 1 is a protective overcoat layer 7, such as of a diamond-like carbon (DLC), formed over magnetically hard layer 6, and a lubricant topcoat layer 8, such as of a perfluoropolyether (PFPE) material, formed over the protective overcoat layer.

Substrate 2, in hard disk applications, is disk-shaped and comprised of a non-magnetic metal or alloy, e.g., Al or an Al-based alloy, such as Al—Mg having a Ni—P plating layer on the deposition surface thereof, or alternatively, substrate 2 is comprised of a suitable glass, ceramic, glass-ceramic, polymer, or a composite or laminate of these materials. Optional adhesion layer 3, if present on substrate surface 2, may comprise a less than about 200 Å thick layer of a metal or a metal alloy material such as Ti, a Ti-based alloy, Ta, a Ta-based alloy, Cr, or a Cr-based alloy. The relatively thick soft magnetic underlayer 4 may be comprised of an about 50 to about 300 nm thick layer of a soft magnetic material such as Ni, Co, Fe, an Fe-containing alloy such as NiFe (Permalloy), FeN, FeSiAl, FeSiAlN, a Co-containing alloy such as CoZr, CoZrCr, CoZrNb, or a Co—Fe-containing alloy such as CoFeZrNb, CoFe, FeCoB, and FeCoC. Relatively thin interlayer stack 5 may comprise an about 50 to about 300 Å thick layer or layers of non-magnetic material(s). Interlayer stack 5 includes a seed layer 5_{B}, adjacent the magnetically soft underlayer (SUL) 4, which typically comprises a less than about 100 Å thick layer of an fcc material, such as an alloy of Cu, Ag, Pt, or Au, or an amorphous or fine-grained material, such as Ta, TaW, CrTa, Ti, TiN, TiW, or TiCr. Overlying seed layer 5_{B} and adjacent the magnetically hard perpendicular recording layer 6 is at least one interlayer 5_{A} of a hcp non-magnetic material, such as Ru, Ta/Ru, TaX/RuY (where X=Ti or Ta and Y=Cr, Mo, W, B, Nb, Zr, Hf, or Re), Ru/CoCrZ (where CoCrZ is non-magnetic and Z=Pr, Ru, Ta, Nb, Zr, W, or Mo). The at least one magnetically hard perpendicular recording layer 6 may comprise one or more of about 10 to about 25 nm thick layers of Co-based alloys including one or more elements selected from the group consisting of Cr, Fe, Ta, Ni, Mo, Pt, W, Cr, Ru, Ti, Si, O, V, Nb, Ge, B, and Pd.

A currently employed way of classifying magnetic recording media is on the basis by which the magnetic grains of the recording layer are mutually separated, i.e., segregated, in order to physically and magnetically de-couple the grains and provide improved media performance characteristics. According to this classification scheme, magnetic media with Co-based alloy magnetic recording layers (e.g., CoCr alloys) are classified into two distinct types: (1) a first type, wherein segregation of the grains occurs by diffusion of Cr atoms of the magnetic layer to the grain boundaries of the layer to form Cr-rich grain boundaries, which diffusion process requires heating of the media substrate during formation (deposition) of the magnetic layer; and (2) a second type, wherein segregation of the grains occurs by formation of non-magnetic oxides, nitrides, and/or carbides at the boundaries between adjacent magnetic grains to form so-called “granular” media, which oxides, nitrides, and/or carbides may be formed by introducing a minor amount of at least one reactive gas containing oxygen, nitrogen, and/or carbon atoms (e.g. O₂, N₂, CO₂, etc.) to the inert gas (e.g., Ar) atmosphere during sputter deposition of the Co alloy-based magnetic layer.

Magnetic recording media with granular magnetic recording layers possess great potential for achieving ultra-high areal recording densities. More specifically, magnetic recording media based upon granular recording layers offer the possibility of satisfying the ever-increasing demands on thin film magnetic recording media in terms of coercivity (H_{c}), remanent coercivity (H_{cr}), magnetic remanence (Mᵣ), coercivity squareness (S*), signal-to-medium noise ratio (SMNR), and thermal stability, as determined by K_{μ}V, where K_{μ} is the magnetic anisotropy constant of the magnetic material and V is the volume of the magnetic grain(s). In addition to the requirements imposed upon aforementioned magnetic performance parameters by the demand for high performance, high areal recording density media, increasingly more stringent demands are made on the flying height of the read/write transducer head, i.e., head-to-media separation (“HMS”). Specifically, since the read/write sensitivity (or signal) of the transducer head is inversely proportional to the spacing between the lower edge of the transducer head and the magnetic recording layer of the media, reduction of the flying height is essential.

As indicated above, current methodology for manufacturing granular-type magnetic recording media involves reactive sputtering of the magnetic recording layer in a reactive gas-containing sputtering atmosphere, e.g., an O₂/Ar and/or N₂/Ar atmosphere, in order to incorporate oxides and/or nitrides therein and achieve smaller and more isolated magnetic grains. In this regard, it is believed that the introduction of O₂ and/or N₂ into the Ar sputtering atmosphere provides a source of O₂ and/or N₂ that migrates to the inter-granular boundaries and forms non-magnetic oxides and/or nitrides within the boundaries, thereby providing a structure with reduced exchange coupling between adjacent magnetic grains. However, magnetic films formed according to such methodology typically are very porous and rough-surfaced compared to media formed utilizing conventional techniques. Corrosion and environmental testing of granular recording media indicate very poor resistance to corrosion and environmental influences, and even relatively thick carbon-based protective overcoats, e.g., ˜40 Å thick, provide inadequate resistance to corrosion and environmental attack. Studies have determined that the root cause of the poor corrosion performance of granular magnetic recording media is incomplete coverage of the surface of the magnetic recording layer by the protective overcoat (typically carbon), due to high nano-scale roughness, porous oxide grain boundaries, and/or poor carbon adhesion to oxides.

Previous studies disclosed in commonly assigned, co-pending application Ser. No. 10/776,223, filed Feb. 12, 2004 (US 2005/0181239 A1), the entire disclosure of which is incorporated herein by reference, have demonstrated that corrosion performance of granular magnetic recording media may be improved by ion etching (e.g., sputter etching) the surface of the granular magnetic recording layer(s) prior to deposition thereon of the carbon protective overcoat layer. However, a disadvantage associated with such methodology is that since the magnetic recording layer(s) is (are) subject to direct ion etching, magnetic material is removed, and as a result, the magnetic properties are altered.

Another approach for improving corrosion resistance of granular magnetic recording media is disclosed in commonly assigned, co-pending application Ser. No. 11/249,469, filed Oct. 14, 2005, the entire disclosure of which is incorporated herein by reference, and comprises formation of a thin, non-magnetic cap layer over the granular magnetic recording layer, followed by ion etching of the exposed surface of the cap layer prior to deposition of a protective overcoat layer (typically carbon-containing) thereon. An advantage afforded by provision of the cap layer is that the magnetic layer(s) underlying the cap layer is (are) effectively shielded from etching, hence damage, by the ion bombardment sputter etching process, and disadvantageous alteration of the magnetic properties and characteristics of the as-deposited, optimized magnetic recording layer(s) is effectively eliminated while maintaining the improved corrosion resistance of the media provided by etching of the media surface prior to deposition of the protective overcoat layer. However, a drawback of this approach is the disadvantageous increase in the HMS arising from the presence of the non-magnetic cap layer in the layer structure overlying the granular magnetic recording layer.

Yet another approach for mitigating the problem of corrosion susceptibility of granular magnetic recording media (disclosed in commonly assigned, co-pending application Ser. No. 11/154,637, filed Jun. 17, 2005, the entire disclosure of which is incorporated herein by reference) comprises formation of a thin, magnetic cap layer containing magnetic grains and non-magnetic grain boundaries over the granular magnetic recording layer prior to deposition of a protective overcoat layer (typically carbon-containing) thereon. According to this approach, the magnetic cap layer: (1) serves to protect the principal granular magnetic recording layer from corrosion; (2) has substantially oxide-free grain boundaries with higher density and lower average porosity than the grain boundaries of the principal granular magnetic recording layer; (3) has a lower average surface roughness than the principal granular magnetic recording layer; and (4) serves both as a magnetically functional layer and a corrosion protection layer, thereby mitigating the drawback associated by the increased HMS.

Still another approach for increasing the corrosion resistance of granular magnetic recording media (disclosed in commonly assigned, co-pending application Ser. No. 11/407,927 filed Apr. 21, 2006, the entire disclosure of which is incorporated herein by reference) comprises interposing at least one tunable intermediate magnetic layer between granular magnetic recording layer and corrosion preventing magnetic cap layers in order to obtain a significant improvement in magnetic recording parameters, while maintaining the enhanced corrosion resistance provided by the magnetic cap layer. Interposition of the intermediate magnetic layer in proper (i.e., optimal) thickness and/or composition ranges also results in an optimal amount of magnetic exchange de-coupling between the granular magnetic recording and the cap layers.

The continuing requirements for increased recording density and high performance of magnetic media, particularly in hard disk form, necessitates parallel increases in Bit Error Rate (“BER”) and SMNR requirements. As a consequence, and notwithstanding the notable improvements in media performance afforded by the above-described principal granular magnetic recording layer+magnetic cap layer approach for providing corrosion-resistant, high areal recording density, high performance granular magnetic recording media, further improvement in granular media technology and performance for meeting the increased BER and SMNR requirements of high performance disk drives is considered of utmost significance.

In view of the foregoing, there exists a clear need for methodology for manufacturing high areal recording density, high performance granular-type perpendicular magnetic recording media with improved corrosion resistance and optimal magnetic properties, which methodology is fully compatible with the requirements of high product throughput, cost-effective, automated manufacture of such high performance magnetic recording media.

The present invention, therefore, addresses and solves the above-described problems, drawbacks, and disadvantages associated with the aforementioned methodology for the manufacture of high performance magnetic recording media comprising granular-type magnetic recording layers, while maintaining full compatibility with all aspects of automated manufacture of magnetic recording media.

### DISCLOSURE OF THE INVENTION

An advantage of the present invention is an improved method of manufacturing granular perpendicular magnetic recording media.

Another advantage of the present invention is an improved granular perpendicular magnetic recording media with increased corrosion resistance.

Yet another advantage of the present invention is improved granular perpendicular magnetic recording media.

Still another advantage of the present invention is improved granular perpendicular magnetic recording media with increased corrosion resistance.

Additional advantages and other features of the present disclosure will be set forth in the description which follows and part will become apparent to those having ordinary skill in the art upon examination of the following or may be learned from the practice of the present invention. The advantages of the present invention may be realized and obtained as particularly pointed out in the appended claims.

According to an aspect of the present invention, the foregoing and other advantages are obtained in part by a method of manufacturing a granular perpendicular magnetic recording medium, comprising sequential steps of:

(a) providing a non-magnetic substrate including a surface;

(b) forming a soft magnetic underlayer (SUL) over the surface;

(c) heating the SUL;

(d) forming an intermediate layer stack over the heated SUL; and

(e) forming at least one granular, magnetically hard perpendicular magnetic recording layer over the intermediate layer stack.

In accordance with embodiments of the present invention, step (c) comprises post-deposition heating the SUL to form the intermediate layer stack in step (d) with a smoother surface and the granular perpendicular magnetic recording layer in step (e) with greater corrosion resistance than when step (c) is not performed. Preferably, step (c) comprises heating the SUL to an elevated temperature and for an interval sufficient to form the intermediate layer stack with an AFM ΔΘ 50 surface roughness not greater than about 13°; and steps (a)-(e) are performed by transporting the substrate through respective dedicated processing chambers of a multi-chamber apparatus, and at least formation of the intermediate layer stack in step (d) occurs with the SUL at or near the elevated temperature achieved in step (c).

According to embodiments of the present invention, step (c) comprises heating the SUL to a temperature in the range from about 120 to about 130° C. for from about 3 to about 4 sec.; step (b) comprises forming the SUL with a thickness in the range from about 500 to about 1200 Å from a soft magnetic material selected from the group consisting of: Ni, Co, Fe, NiFe (Permalloy), FeN, FeSiAl, FeSiAlN, CoZr, CoZrCr, CoZrTa, CoZrNb, CoFeZrTa, CoFeZrNb, CoFe, FeCoB, FeCoCrB, and FeCoC; and step (d) comprises forming the intermediate layer stack with a non-magnetic seed layer adjacent the SUL and at least one non-magnetic interlayer overlying the seed layer.

Embodiments of the present invention include those wherein step (d) comprises forming the seed layer from an fcc material selected from the group consisting of: alloys of Cu, Ag, Pt, and Au, or from an amorphous or fine-grained material selected from the group consisting of: Ta, TaW, CrTa, Ti, TiN, TiW, and TiCr; and forming the at least one non-magnetic interlayer from at least one material selected from the group consisting of: Ru, Ta/Ru, TaX/RuY, where X=Ti or Ta and Y=Cr, Mo, W, B, Nb, Zr, Hf, or Re, and Ru/CoCrZ, where CoCrZ is non-magnetic and Z=Pr, Ru, Ta, Nb, Zr, W, or Mo.

According to embodiments of the present invention, step (e) comprises forming the at least one granular, magnetically hard perpendicular magnetic recording layer from at least one Co-based alloy including one or more elements selected from the group consisting of: Cr, Fe, Ta, Ni, Mo, Pt, W, Cr, Ru, Ti, Si, O, V, Nb, Ge, B, and Pd; and the at least one granular, magnetically hard perpendicular magnetic recording layer is formed with an ESCA CoOₓ takeoff thickness in the range from about 30 to about 60 Å. Preferably, step (e) comprises forming the at least one granular, magnetically hard perpendicular magnetic recording layer by sputter deposition in a reactive gas-containing sputtering atmosphere selected from the group consisting of: O₂/Ar, N₂/Ar, and CO₂/Ar atmospheres; and step (a) comprises providing a non-magnetic substrate selected from the group consisting of: Al, Al-based alloys, Ni—P plated Al, glass, ceramic, glass-ceramic, polymer, and composites or laminates of these materials.

Another aspect of the present invention is improved granular perpendicular magnetic recording medium fabricated according to the above method.

Yet another aspect of the present invention is a granular perpendicular magnetic recording medium, comprising:

(a) a non-magnetic substrate including a surface;

(b) a soft magnetic underlayer (SUL) overlying the surface, the SUL having a surface with an AFM ΔΘ 50 roughness not greater than about 13°;

(c) an intermediate layer stack overlying the surface of the SUL; and

(d) at least one granular, magnetically hard perpendicular magnetic recording layer overlying the intermediate layer stack.

According to preferred embodiments of the present invention, the SUL is from about 500 to about 1200 Å thick and comprises a soft magnetic material selected from the group consisting of: Ni, Co, Fe, NiFe (Permalloy), FeN, FeSiAl, FeSiAlN, CoZr, CoZrCr, CoZrTa, CoZrNb, CoFeZrTa, CoFeZrNb, CoFe, FeCoB, FeCoCrB, and FeCoC; and the intermediate layer stack includes a non-magnetic seed layer adjacent the SUL and at least one non-magnetic interlayer overlying the seed layer.

Embodiments of the present invention include those wherein the seed layer comprises an fcc material selected from the group consisting of: alloys of Cu, Ag, Pt, and Au, or an amorphous or fine-grained material selected from the group consisting of: Ta, TaW, CrTa, Ti, TiN, TiW, and TiCr; and the at least one non-magnetic interlayer comprises at least one material selected from the group consisting of: Ru, Ta/Ru, TaX/RuY, where X=Ti or Ta and Y=Cr, Mo, W, B, Nb, Zr, Hf, or Re, and Ru/CoCrZ, where CoCrZ is non-magnetic and Z=Pr, Ru, Ta, Nb, Zr, W, or Mo.

Preferably, the at least one granular, magnetically hard perpendicular magnetic recording layer has an ESCA CoOₓ takeoff thickness in the range from about 30 to about 60 Å and comprises at least one Co-based alloy including one or more elements selected from the group consisting of: Cr, Fe, Ta, Ni, Mo, Pt, W, Cr, Ru, Ti, Si, O, V, Nb, Ge, B, and Pd.

Additional advantages and aspects of the present disclosure will become readily apparent to those skilled in the art from the following detailed description, wherein embodiments of the present methodology and media are shown and described, simply by way of illustration of the best mode contemplated for practicing the present invention. As will be described, the present disclosure is capable of other and different embodiments, and its several details are susceptible of modification in various obvious respects, all without departing from the spirit of the present invention. Accordingly, the drawings and description are to be regarded as illustrative in nature, and not as limitative.

### BRIEF DESCRIPTION OF THE DRAWINGS

The following detailed description of the embodiments of the present invention can best be understood when read in conjunction with the following drawings, in which the same reference numerals are employed throughout for designating the same or similar features, and wherein the various features are not necessarily drawn to scale but rather are drawn as to best illustrate the pertinent features, wherein:

FIG. 1 schematically illustrates, in simplified cross-sectional view, a portion of a conventional magnetic recording, storage, and retrieval system comprised of a conventionally structured granular perpendicular magnetic recording medium and a single-pole magnetic transducer head;

FIG. 2 schematically illustrates, in simplified cross-sectional view, a portion of a granular perpendicular magnetic recording medium according to an illustrative, but non-limitative, embodiment of the present invention; and

FIG. 3 is a graph illustrating the effects of substrate materials, SUL thickness, SUL post-deposition temperature (in terms of applied heater power), and granular perpendicular magnetic recording layer thickness on corrosion resistance of the latter (in terms of ESCA CoOₓ takeoff thickness) and surface roughness of the non-magnetic interlayer (in terms of AFM ΔΘ 50 roughness) for illustrative, but non-limitative, embodiments of the present invention.

### DESCRIPTION OF THE INVENTION

The present invention addresses and solves problems, disadvantages, and drawbacks associated with the poor corrosion and environmental resistance of granular perpendicular magnetic recording media fabricated according to prior methodologies, and is based upon recent investigations by the present inventors which have determined that the underlying cause of the poor corrosion performance of such media is attributable, inter alia, to increased nano-scale roughness of granular magnetic recording layers, relative to that of several other types of magnetic recording layers, and the presence of porous grain boundaries.

Specifically, the present inventors have determined that during the extended interval required for sputter deposition of the relatively thick SUL in the dedicated SUL deposition chamber of the manufacturing apparatus (“sputter tool”), the kinetic energy of the bombarding atoms and ions present in the plasma atmosphere of the sputter tool are converted into thermal energy, thereby increasing the temperature of the workpiece (i.e., substrate with stack of thin film layers formed thereon). The resultant precise (or exact) temperature of the workpiece depends, inter alia, upon the substrate material (e.g., Al—NiP, glass, etc.), substrate form factor, SUL thickness, sputter tool configuration, transport time between deposition of the SUL in the dedicated SUL deposition chamber and subsequent deposition of the intermediate and granular perpendicular magnetic recording layers, etc., in their respective dedicated deposition chambers, and thus can experience significant variation. A disadvantageous result of the variation of the workpiece temperature subsequent to SUL deposition is large variation in the morphology of the intermediate seed and interlayers, as well as that of the granular perpendicular magnetic recording layer(s).

A measure of the corrosion resistance (or susceptibility) of Co alloy-based granular perpendicular magnetic recording layer(s) is provided by measurement of the growth of CoOₓ derived therefrom, as by ESCA technology. Because the CoOₓ corrosion performance of granular media is a sensitive function of the interlayer and granular layer morphology, the lack of temperature control of the workpiece subsequent to deposition of the SUL can lead to unpredictable and poor corrosion performance. In particular, when the workpiece temperature is too low during interlayer and magnetic recording layer deposition, due to, for example, thinner SUL thicknesses, thick substrates, high thermal emissivity substrates (e.g., glass), or increased interval (or delay) between successive deposition stations or chambers, the corrosion performance of the resultant granular perpendicular media disadvantageously incur degradation due to an excessively wide distribution of grain boundary widths and/or high grain roughness.

The present invention is based upon the discovery by the present inventors that the aforementioned problems of poor corrosion and environmental resistance of granular magnetic recording layers can be mitigated, if not entirely eliminated, by performing a suitable post-deposition heat treatment of the soft magnetic underlayer (SUL) of the perpendicular media. According to the present invention, the manufacturing apparatus is modified by placement of a heater means in a chamber located between the SUL deposition chamber and the first intermediate layer deposition chamber, e.g., a seed layer deposition chamber. According to the invention, placement of a dedicated heater station or chamber immediately after the SUL deposition station or chamber provides controlled, rather than imprecise, post-deposition heating of the workpiece with SUL, thereby establishing a desirable temperature for intermediate layer (i.e., seed and at least one interlayer) and magnetic recording layer deposition thereon. As a consequence of the controlled post-deposition heating of the workpiece with SUL formed thereon, the subsequently deposited intermediate and magnetic recording layers grow with a desirable film morphology with grains having narrow grain boundaries and lower roughness (improved smoothness). The resultant granular perpendicular magnetic media exhibit improved and predictable corrosion performance, independent of the substrate type, substrate form factor, and SUL thickness.

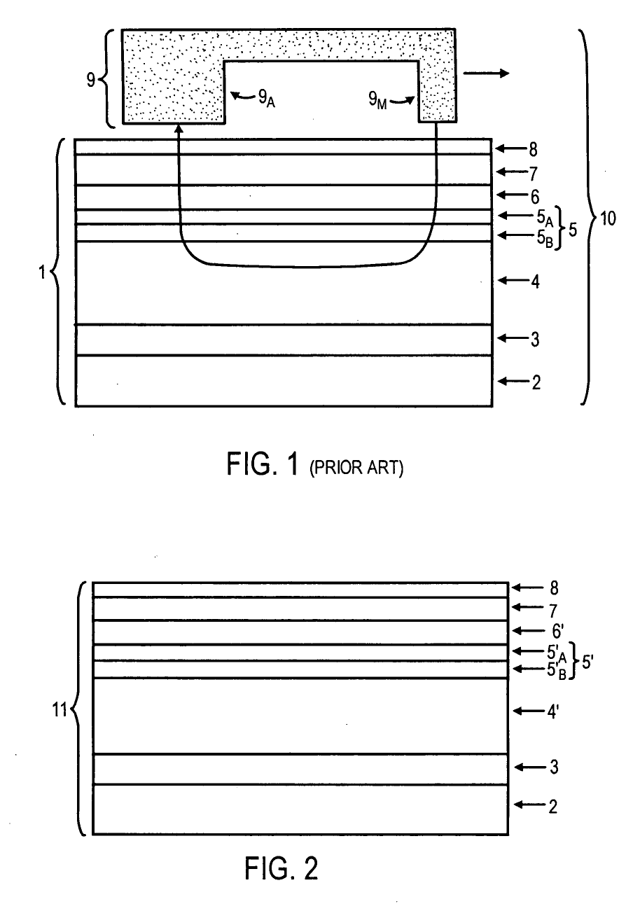

Referring to FIG. 2, schematically illustrated therein, in simplified cross-sectional view, is a portion of a magnetic recording medium 11 according to an illustrative, but non-limitative, embodiment of the present invention. More specifically, medium 11 according to the present invention generally resembles the conventional perpendicular medium 1 of FIG. 1, and comprises a series of thin film layers arranged in an overlying (i.e., stacked) sequence on a non-magnetic substrate 2 comprised of a non-magnetic material selected from the group consisting of: Al, Al—Mg alloys, other Al-based alloys, NiP-plated Al or Al-based alloys, glass, ceramics, glass-ceramics, polymeric materials, and composites or laminates of these materials.

The thickness of substrate 2 is not critical; however, in the case of magnetic recording media for use in hard disk applications, substrate 2 must be of a thickness sufficient to provide the necessary rigidity. Substrate 2 typically comprises Al or an Al-based alloy, e.g., an Al—Mg alloy, or glass or glass-ceramics, and, in the case of Al-based substrates, includes a plating layer, typically of NiP, on the surface of substrate 2 (not shown in the figure for illustrative simplicity). An optional adhesion layer 3, typically a less than about 100-200 Å thick layer of an amorphous metallic material or a fine-grained material, such as a metal or a metal alloy material, e.g., Ti, a Ti-based alloy, Ta, a Ta-based alloy, Cr, or a Cr-based alloy, may be formed over the surface of substrate surface 2 or the NiP plating layer thereon.

Overlying substrate 2 or optional adhesion layer 3 is a thin magnetically soft underlayer (SUL) 4′ having a thickness in the range from about 500 to about 1200 Å and comprising a soft magnetic material selected from the group consisting of: Ni, Co, Fe, NiFe (Permalloy), FeN, FeSiAl, FeSiAlN, CoZr, CoZrCr, CoZrTa, CoZrNb, CoFeZrTa, CoFeZrNb, CoFe, FeCoB, FeCoCrB, and FeCoC. According to the invention, SUL 4′ has received a post-deposition heat treatment in a chamber positioned between the SUL deposition chamber and the first intermediate layer deposition chamber.

Still referring to FIG. 2, the layer stack of medium 11 further comprises a non-magnetic intermediate layer stack 5′ between SUL 4′ and at least one overlying perpendicular magnetic recording layer 6′, which intermediate layer stack 5′ is comprised of seed layer 5′_{B} and interlayer 5′_{A} for facilitating a preferred perpendicular growth orientation of the overlying at least one perpendicular magnetic recording layer 6′. Seed layer 5′_{B} is adjacent the magnetically soft underlayer (SUL) 4′, and typically comprises a less than about 100 Å thick layer of an fcc material, such as an alloy of Cu, Ag, Pt, or Au, or an amorphous or fine-grained material, such as Ta, TaW, CrTa, Ti, TiN, TiW, or TiCr. Overlying seed layer 5′_{B} is at least one 90 to about 110 Å thick interlayer 5′_{A} of an hcp non-magnetic material, such as Ru, Ta/Ru, TaX/RuY (where X=Ti or Ta and Y=Cr, Mo, W, B, Nb, Zr, Hf, or Re), Ru/CoCrZ (where CoCrZ is non-magnetic and Z=Pr, Ru, Ta, Nb, Zr, W, or Mo). According to the invention, the post-deposition heat treatment of SUL 4′ comprises heating the SUL for an interval in the range from about 3 to about 4 sec. to achieve an elevated temperature in the range from about 120 to about 130° C., thereby facilitating formation of the upper surface of the uppermost interlayer 5′_{A} of intermediate layer stack 5′ with an AFM ΔΘ 50 surface roughness not greater than about 13°.

Overlying and in contact with the upper surface of interlayer 5′_{A} is the lower surface of magnetically hard perpendicular recording layer 6′. The magnetically hard perpendicular recording layer 6′ may comprise one or several stacked layers, each comprising at least one Co-based alloy including one or more elements selected from the group consisting of: Cr, Fe, Ta, Ni, Mo, Pt, W, Cr, Ru, Ti, Si, O, V, Nb, Ge, B, and Pd. According to the invention, the uppermost magnetic recording layer preferably has an ESCA CoOₓ takeoff thickness in the range from about 30 to about 60 Å.

Finally, the layer stack of medium 11 includes a protective overcoat layer 7 over the perpendicular magnetic recording layer 6′ and a lubricant topcoat layer 8 over the protective overcoat layer 7. Preferably, the protective overcoat layer 7 comprises a carbon-based material, e.g., diamond-like carbon (“DLC”), and the lubricant topcoat layer 8 comprises a fluoropolymer material, e.g., a perfluoropolyether compound.

According to the invention, each of the layers 3, 4′, 5′_{B}, 5′_{A}, 6′, and 7 may be deposited or otherwise formed by any suitable technique utilized for formation of thin film layers, e.g., any suitable physical vapor deposition (“PVD”) technique, including but not limited to, sputtering, vacuum evaporation, ion plating, cathodic arc deposition (“CAD”), etc., or by any combination of various PVD techniques. However, the at least one granular perpendicular magnetic recording layer 6′ is preferably deposited by sputtering of a Co-containing target in a reactive gas-containing sputtering atmosphere selected from the group consisting of: O₂/Ar, N₂/Ar, and CO₂/Ar atmospheres. The lubricant topcoat layer 8 may be provided over the upper surface of the protective overcoat layer 7 in any convenient manner, e.g., as by dipping the thus-formed medium into a liquid bath containing a solution of the lubricant compound.

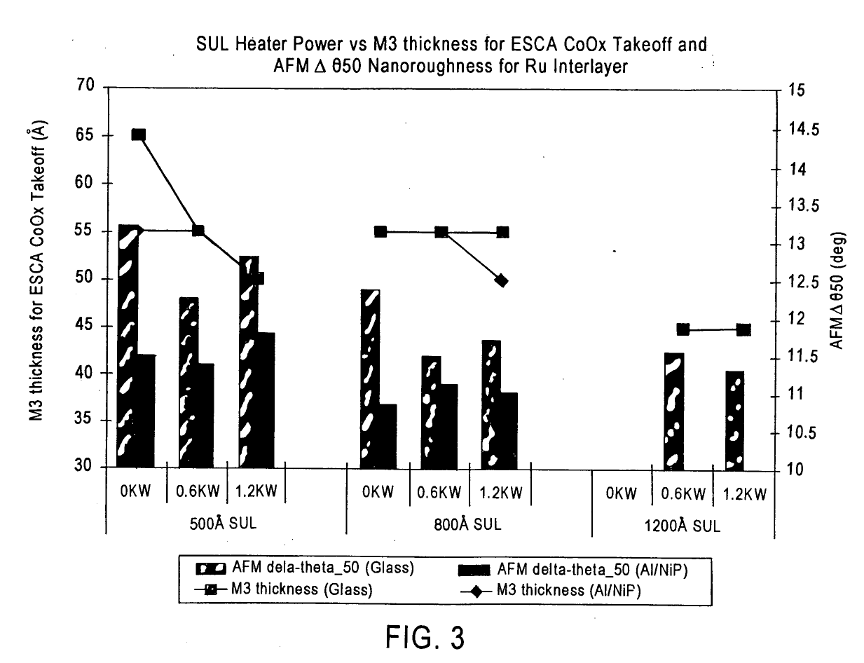

Adverting to FIG. 3, shown therein is a graph illustrating the effects of substrate materials, SUL thickness, SUL post-deposition temperature (in terms of applied heater power), and granular perpendicular magnetic recording layer thickness on corrosion resistance of the latter (in terms of ESCA CoOₓ takeoff thickness) and surface nano-roughness of the non-magnetic interlayer (in terms of AFM ΔΘ 50 roughness) for illustrative, but non-limitative, embodiments of the present invention. The tested media comprised two (2) stacked Ru interlayers, i.e., a first interlayer (Ru₁) about 100 Å thick in overlying contact with a seed layer 5′_{B}, and a second interlayer (Ru₂) about 100 Å thick overlying the first interlayer; and three (3) stacked, Co-oxide based granular perpendicular magnetic recording layers 6′, i.e., a first magnetic layer (M₁) about 100 Å thick in overlying contact with the second interlayer (Ru₂), a second magnetic layer (M₂) overlying the first magnetic layer (M₁), and a third (uppermost) magnetic layer (M₃) overlying the second magnetic layer (M₂).

The media were evaluated for corrosion performance by varying the temperature of the SUL post-deposition heat treatment by varying the power applied to the heater of the post-deposition chamber. Comparison was made with media fabricated without SUL post-deposition treatment and with Al/NiP and glass substrates. Corrosion performance of the tested media was measured by determining the ESCA CoOₓ content of the third (uppermost) granular magnetic recording layer (M₃) before and after four (4) day exposure to an 80% relative humidity/80° C. environment. Investigations have shown that the nano-roughness of the second interlayer (Ru₂) correlates well with the ESCA CoOₓ performance. Other investigations have determined that the nano-roughness of the second interlayer (Ru₂) decreases with increasing SUL thickness or decreasing thickness of the second interlayer (Ru₂).

FIG. 3 shows the interrelationship between SUL heater power during post-deposition heat treatment (hence achieved temperature of the SUL/substrate), nano-roughness of the second interlayer (Ru₂), and ESCA CoOₓ performance of the tested media at different SUL thicknesses. In the following, the thickness of the third (uppermost) granular magnetic recording layer (M₃) at which the CoOₓ content begins to increase, hereinafter referred to as the “CoOₓ takeoff point”, is utilized as a figure of merit for corrosion performance, lower CoOₓ takeoff points (thicknesses) indicating better corrosion performance (resistance). The following conclusions may be drawn from FIG. 3:

1. it is confirmed that as the SUL thickness increases, the nano-roughness metric AFM ΔΘ 50 of the second interlayer (Ru₂) on both glass and Al/NiP substrates shows a decreasing trend (the effect being more pronounced on the glass substrates than the Al/NiP substrates). The decrease in AFM ΔΘ 50 nano-roughness indicates that the surface of the second interlayer (Ru₂) becomes smoother as the SUL thickness increases. In addition the ESCA CoOₓ takeoff point decreases as the SUL thickness increases;

2. as the heater power (hence achieved temperature of the SUL/substrate) increases, the AFM ΔΘ 50 nano-roughness of the second interlayer (Ru₂) decreases for glass substrates, and the CoOₓ takeoff point decreases for both glass and Al/NiP substrates; and

3. the ESCA CoOₓ takeoff thickness of the uppermost magnetic recording layer (M₃) is preferably within the range from about 30 to about 60 Å.

The results shown in FIG. 3 clearly demonstrate that post-deposition heating of the SUL improves the corrosion performance of granular perpendicular magnetic recording media by reducing surface nano-roughness of the interlayer, thereby facilitating formation thereon of granular perpendicular magnetic recording layers with reduced surface nano-roughness and increased corrosion resistance.

Thus, the present invention advantageously provides improved performance, high areal density, granular perpendicular magnetic media, which media include soft magnetic underlayers (SUL's) subjected to post-deposition heat treatment affording improved corrosion performance, i.e., increased corrosion resistance. The media of the present invention enjoy particular utility in high recording density systems for computer-related applications. In addition, the inventive media can be readily fabricated by means of conventional media manufacturing technologies and instrumentalities, e.g., sputtering tools.

In the previous description, numerous specific details are set forth, such as specific materials, structures, processes, etc., in order to provide a better understanding of the present invention. However, the present invention can be practiced without resorting to the details specifically set forth. In other instances, well-known processing materials and techniques have not been described in detail in order not to unnecessarily obscure the present invention.

Only the preferred embodiments of the present invention and but a few examples of its versatility are shown and described in the present disclosure. It is to be understood that the present invention is capable of use in various other combinations and environments and is susceptible of changes and/or modifications within the scope of the inventive concept as expressed herein.

What is claimed is:

1. A method of manufacturing a granular perpendicular magnetic recording medium, comprising sequential steps of:
(a) providing a non-magnetic substrate including a surface;
(b) forming a soft magnetic underlayer (SUL) over said surface;
(c) heating said SUL;
(d) forming an intermediate layer stack over said heated SUL; and
(e) forming at least one granular, magnetically hard perpendicular magnetic recording layer over said intermediate layer stack.

2. The method as in claim 1, wherein:
step (c) comprises post-deposition heating said SUL to form said intermediate layer stack in step (d) with a smoother surface and said granular perpendicular magnetic recording layer in step (e) with greater corrosion resistance than when step (c) is not performed.

3. The method as in claim 2, wherein:
step (c) comprises heating said SUL to an elevated temperature and for an interval sufficient to form said intermediate layer stack with an AFM ΔΘ 50 surface roughness not greater than about 13°.

4. The method as in claim 3, wherein:
steps (a)-(e) are performed by transporting said substrate through respective dedicated processing chambers of a multi-chamber apparatus, and at least formation of said intermediate layer stack in step (d) occurs with said SUL at or near said elevated temperature achieved in step (c).

5. The method as in claim 3, wherein:
step (c) comprises heating said SUL to a temperature in the range from about 120 to about 130° C. for from about 3 to about 4 sec.

6. The method as in claim 1, wherein:
step (b) comprises forming said SUL from a soft magnetic material selected from the group consisting of: Ni, Co, Fe, NiFe (Permalloy), FeN, FeSiAl, FeSiAlN, CoZr, CoZrCr, CoZrTa, CoZrNb, CoFeZrTa, CoFeZrNb, CoFe, FeCoB, FeCoCrB, and FeCoC.

7. The method as in claim 6, wherein:
step (b) comprises forming said SUL with a thickness in the range from about 500 to about 1200 Å.

8. The method as in claim 1, wherein:
step (d) comprises forming said intermediate layer stack with a non-magnetic seed layer adjacent said SUL and at least one non-magnetic interlayer overlying said seed layer.

9. The method as in claim 8, wherein:
step (d) comprises forming said seed layer from an fcc material selected from the group consisting of: alloys of Cu, Ag, Pt, and Au, or from an amorphous or fine-grained material selected from the group consisting of: Ta, TaW, CrTa, Ti, TiN, TiW, and TiCr.

10. The method as in claim 8, wherein:
step (d) comprises forming said at least one non-magnetic interlayer from at least one material selected from the group consisting of: Ru, Ta/Ru, TaX/RuY, where X=Ti or Ta and Y=Cr, Mo, W, B, Nb, Zr, Hf, or Re, and Ru/CoCrZ, where CoCrZ is non-magnetic and Z=Pr, Ru, Ta, Nb, Zr, W, or Mo.

11. The method as in claim 1, wherein:
step (e) comprises forming said at least one granular, magnetically hard perpendicular magnetic recording layer from at least one Co-based alloy including one or more elements selected from the group consisting of: Cr, Fe, Ta, Ni, Mo, Pt, W, Cr, Ru, Ti, Si, O, V, Nb, Ge, B, and Pd.

12. The method as in claim 11, wherein:
step (e) comprises forming said at least one granular, magnetically hard perpendicular magnetic recording layer with an ESCA CoOₓ takeoff thickness in the range from about 30 to about 60 Å.

13. The method as in claim 11, wherein:
step (e) comprises forming said at least one granular, magnetically hard perpendicular magnetic recording layer by sputter deposition in a reactive gas-containing sputtering atmosphere selected from the group consisting of: O₂/Ar, N₂/Ar, and CO₂/Ar atmospheres.

14. The method as in claim 1, wherein:
step (a) comprises providing a non-magnetic substrate selected from the group consisting of: Al, Al-based alloys, Ni—P plated Al, glass, ceramic, glass-ceramic, polymer, and composites or laminates of these materials.

15. A granular perpendicular magnetic recording medium fabricated according to the method of claim 3.

16. A granular perpendicular magnetic recording medium, comprising:
(a) a non-magnetic substrate including a surface;
(b) a soft magnetic underlayer (SUL) overlying said surface, said SUL having a surface with an AFM ΔΘ 50 roughness not greater than about 13°;
(c) an intermediate layer stack overlying said surface of said SUL; and
(d) at least one granular, magnetically hard perpendicular magnetic recording layer overlying said intermediate layer stack.

17. The medium according to claim 16, wherein:
said SUL is from about 500 to about 1200 Å thick and comprises a soft magnetic material selected from the group consisting of: Ni, Co, Fe, NiFe (Permalloy), FeN, FeSiAl, FeSiAlN, CoZr, CoZrCr, CoZrTa, CoZrNb, CoZrFeTa, CoFeZrNb, CoFe, FeCoB, FeCoCrB, and FeCoC.

18. The medium according to claim 16, wherein:
said intermediate layer stack includes a non-magnetic seed layer adjacent said SUL and at least one non-magnetic interlayer overlying said seed layer.

19. The medium according to claim 18, wherein:
said seed layer comprises an fcc material selected from the group consisting of: alloys of Cu, Ag, Pt, and Au, or an amorphous or fine-grained material selected from the group consisting of: Ta, TaW, CrTa, Ti, TiN, TiW, and TiCr; and
said at least one non-magnetic interlayer comprises at least one material selected from the group consisting of: Ru, Ta/Ru, TaX/RuY, where X=Ti or Ta and Y=Cr, Mo, W, B, Nb, Zr, Hf, or Re, and Ru/CoCrZ, where CoCrZ is non-magnetic and Z=Pr, Ru, Ta, Nb, Zr, W, or Mo.

20. The medium according to claim 16, wherein:
said at least one granular, magnetically hard perpendicular magnetic recording layer has an ESCA CoOₓ takeoff thickness in the range from about 30 to about 60 Å and comprises at least one Co-based alloy including one or more elements selected from the group consisting of: Cr, Fe, Ta, Ni, Mo, Pt, W, Cr, Ru, Ti, Si, O, V, Nb, Ge, B, and Pd.
